(19) United States
(12) Patent Application Publication
(10) Pub. No.: US 2015/0116487 A1
(43) Pub. Date: Apr. 30, 2015

(54) Method for Video-Data Indexing Using a Map

(71) Applicant: OBSHESTVO S OGRANICHENNOY OTVETSTVENNOSTYU ''SINEZIS'', Moscow (RU)

(72) Inventor: Nikolay Ptitsyn, Moscow (RU)

(21) Appl. No.: 14/381,997

(22) PCT Filed: Mar. 29, 2013
(86) PCT No.: PCT/RU2013/000266

§ 371 Date: Dec. 22, 2014

(30) Foreign Application Priority Data
May 15, 2012 (RU) 2012119844

(51) Int. Cl. G06F 17/30; H04N 7/18

(52) U.S. Cl. CPC G06F 17/30858; H04N 7/183
USPC 348/143

(57) ABSTRACT

The method for video-data indexing using a map comprises the following steps: video data are obtained from at least one camera; the video data are used to locate at least one moving object and to estimate the object position and/or motion parameters in a two-dimensional video frame coordinate system (the object position on the video frame); the position and/or motion parameters of the located object are converted from the two-dimensional frame coordinate system into a two-dimensional map coordinate system (the object position on the map); at least one index record is generated to relate the video data containing the located object to its position and/or motion parameters on the map; the index record is saved in the database and/or storage.

The invention accelerates and refines search requests for video data containing information about objects moving across the area under video surveillance.

### FIELD OF THE INVENTION

This invention relates to data processing—namely, closed-circuit security television (CCTV), video surveillance, video analytics, video-data storage, and video-data search. The invention enables efficient search and analysis of objects such as people and vehicles under video surveillance for various industries, including safety and security, transportation and retail networks, sports and entertainment, housing and communal services, and social infrastructure. The invention can be used in local and global networks and in dedicated and cloud-based servers.

### BACKGROUND OF THE INVENTION

One of the urgent problems in the development of distributed video-surveillance systems is the large amount of data coming from cameras. On the one hand, modern video-analytics algorithms support automatic object (people, vehicles) detection, tracking, classification, and identification. On the other hand, video analytics generates a considerable amount of object motion data (object locations and/or trajectory metadata) in the camera's field of view. Object search and analysis in large arrays of video data are rather costly in terms of computational resources and time spent by users of video-surveillance systems.

Certain existing video-surveillance systems record object motion data generated by video analytics in the database as trajectories (sequences of locations) in the frame coordinates. The user can search a trajectory database to find a trajectory that matches some criteria in the frame space and time. This approach to object motion trajectory analysis within a single frame has the following disadvantages:

First, using frame coordinates to store the trajectory implies that the user knows the camera that captured the object of interest. This requirement is essentially impracticable in distributed video-surveillance networks with numerous cameras. The user has difficulty operating a large number of cameras and taking into account the geometry of each camera's field of view to set the search criteria.

Second, trajectories of object motion in the frame coordinate system are not equally accurate. Objects in the camera foreground are tracked with high accuracy, and thus redundant details of the trajectory are shown. Objects in the camera background are tracked with low accuracy, and thus certain details of the trajectory are omitted. Direct search through heterogeneous data with different detail levels is inefficient. Object coordinates require conversion and/or indexing to generate homogeneous trajectories.

Third, if two or more cameras detect one and the same object, the overlapping coverage areas of these cameras produce redundant data. This procedure consumes extra database memory and increases the time needed to search and analyse the data because the user receives duplicate records.

Because of the disadvantages described, the archived trajectories in video-surveillance systems occupy a large amount of disk space, and the user has to spend a few hours or even days searching an archive with hundreds of thousands of object trajectories.

The present invention eliminates the problems mentioned and increases the efficiency of object motion data search for the territory monitored by multiple cameras.

One of the major differences between the invention and the prior art described above is that efficient video-data search (including video records and their single frames) involves indexing the data in such a way as to relate object motion parameters to one another; this procedure converts the location of objects calculated by video analytics in the frame coordinate system into the map coordinate system and subsequent map indexing.

### SUMMARY OF THE INVENTION

This invention is a method for video-data indexing using a map; it comprises the following steps:
a. Video data are obtained from at least one camera.
b. The video data are used to locate at least one moving object and to estimate the object position and/or motion parameters in the two-dimensional video frame coordinate system (the object position on the video frame).
c. The position and/or motion parameters of the located object are converted from the two-dimensional frame coordinate system into the two-dimensional map coordinate system (the object position on the map).
d. At least one index record is generated to relate the video data containing the located object to its position and/or motion parameters on the map.
e. The index record is saved in the database and/or storage.

The position and/or motion parameters can be determined using a motion detector.

The position and/or motion parameters can be determined using object detectors, including detectors of people, faces, or number (license) plates.

The position and/or motion parameters can be determined using video analytics embedded in a network camera or video server.

The position and/or motion parameters can be determined using video analytics running on server hardware.

The position and/or motion parameters can be refined using multispectral cameras capturing various parts of the spectrum (visual, thermal) and/or sensors using other physical principles different from those of cameras—for example, radars.

The frame or map position can be visualized for the user by displaying an object label (icon) over the map on the monitor.

The video data can be visualized for the user by displaying them over the map on the monitor.

The located objects can be identified: people can be identified biometrically by their faces and vehicles can be identified by their number (license) plates.

A temporal sequence of object positions on the map—the object movement trajectory—can be stored in a database and/or storage together with the index record.

The position sequence on the map can be compressed before being recorded by a trajectory-smoothing, piecewise-linear approximation or by the spline-approximation method.

The position and/or motion parameters can be continuously determined in the course of real-time object motion.

The video data can be indexed in at least two dimensions.

The position can be converted from the frame coordinates into the map coordinates by means of an affine conversion.

The coordinate-system transformation can be calculated using a one-to-one mapping between a point set on the frame and a point set on the map.

The object position on the map, as determined by the data from one video camera, can be refined, using multiple-camera-tracking (MCT) methods, by comparing it with the data from another camera capturing the same object.

The object positions estimated from multiple cameras can be compared and/or merged into an integral trajectory by estimating the correlation or the least squared error of the object positions on the map.

The video camera can support rotation and/or zoom change with the help of a motorized drive—for example, one having Pan Tilt and Zoom (PTZ) features; in this case, the camera coverage area on the map is adjusted automatically depending on the current-camera PTZ position.

The index record can be related to map regions specified manually by the user of the video-surveillance system.

The index record can be related to map regions automatically specified by the algorithm dividing the map into equal or unequal regions depending on the density of the objects detected in each area, which may overlap with others.

The index record can be related to the object motion direction.

The index record can be related to the object motion speed.

The index record can be related to a tripwire crossed by the object.

The index records can be combined in a hierarchical data structure.

The index record can be related to the time interval of the moving object.

The index record can be related to the number of objects in the area specified.

The index record can include or be related to the minimum and/or maximum distance from a certain point to the object trajectory points.

The index record can include or be related to the minimum bounding box of the object motion trajectory.

The index record can include or be related to the unique object identifier.

The index record can be related to the object type (object class).

The index record can be related to the object motion type determined by the object motion trajectory on the map.

The index record can be related to text tags.

The index record can be saved in a relational database.

### BRIEF DESCRIPTION OF DRAWINGS

FIG. 1. One of several possible embodiments of the method of video-data indexing using a map.

FIG. 2. One of several possible embodiments of the method of searching indexed video data.

FIG. 3. Sample frames received from five different cameras and used to generate the mapped motion trajectories of two people. Their motion trajectories before coordinate transformation are in white.

FIG. 4. Object trajectories from FIG. 3 projected onto the map after the coordinate transformation. The figure shows: a) the perimeter of the building, b) camera locations and coverage areas, c) trajectory projections on the map (square brackets contain the number of the camera capturing the trajectory), d) the map's reference grid.

FIG. 5. Integral trajectories of two objects obtained by combining the multiple trajectories from FIG. 4 with multiple cameras on the map. The two objects are marked with human symbols numbered 2 and 3 beside cameras 1 and 3.

FIG. 6. An index structure that relates map positions and/or motion parameters of the located objects to the video data containing the located objects.

FIG. 7. A graphic user interface (GUI), which inputs object search criteria on the map and enables object search in the indexed video data. The GUI comprises the following tools: (1) rectangular search tool; (2) tripwire search tool; (3) elliptical search tool; (4) free-form search tool.

### DETAILED DESCRIPTION OF THE INVENTION

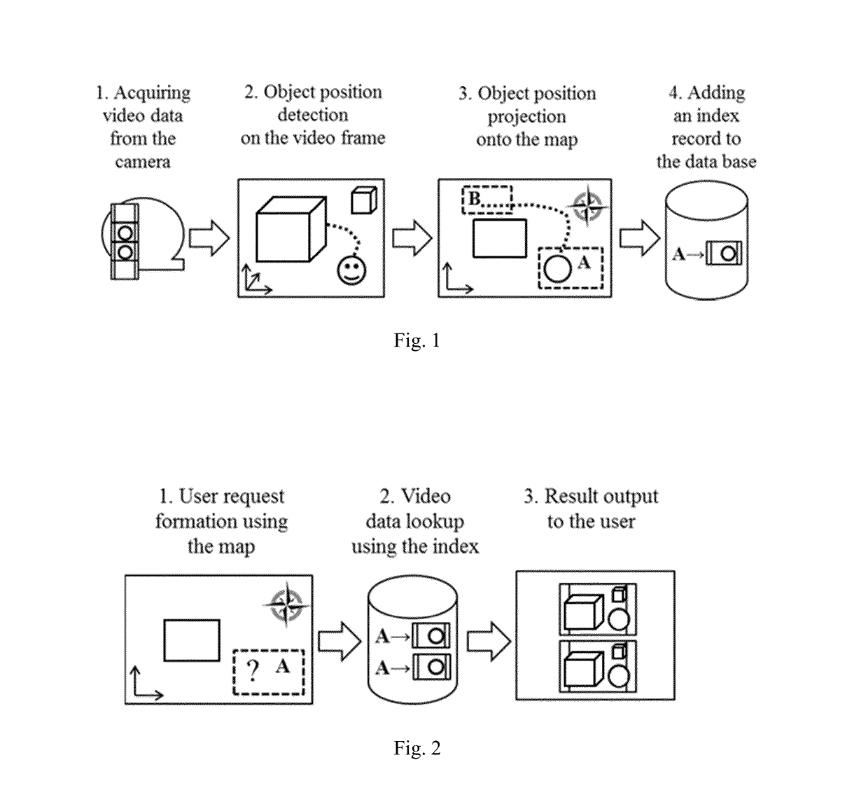

Embodiments of the present invention are described herein with reference to FIGS. 1-7.

The video-data indexing method comprises the following steps, shown in FIG. 1:

Step 1. Receiving Video from a Video Camera

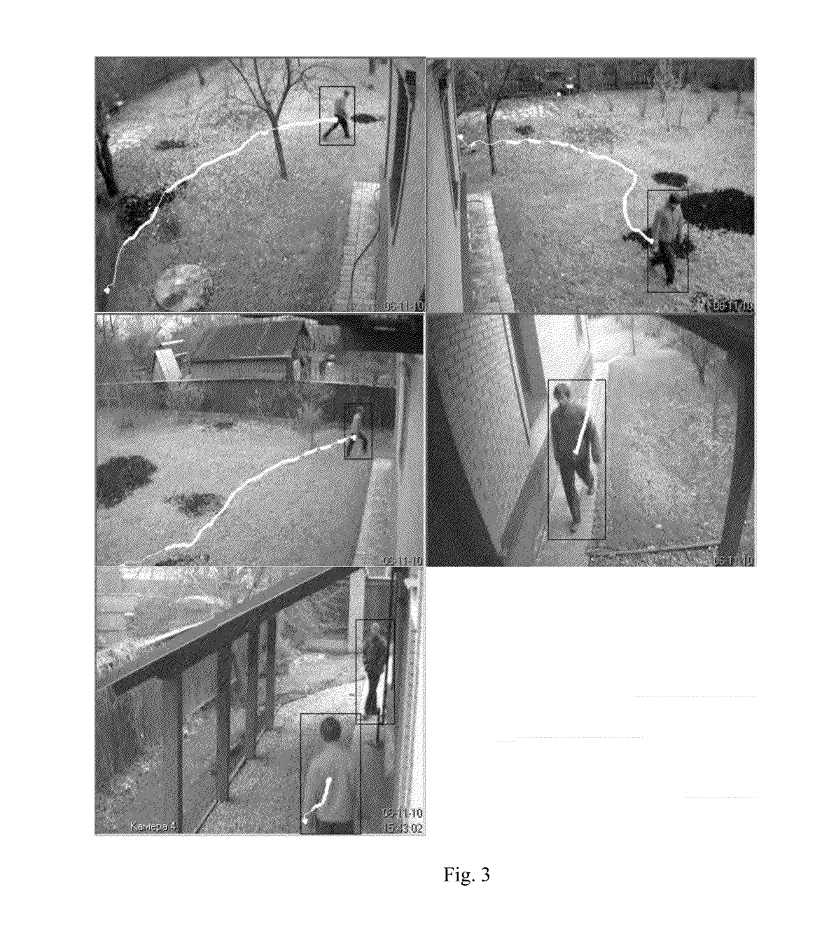

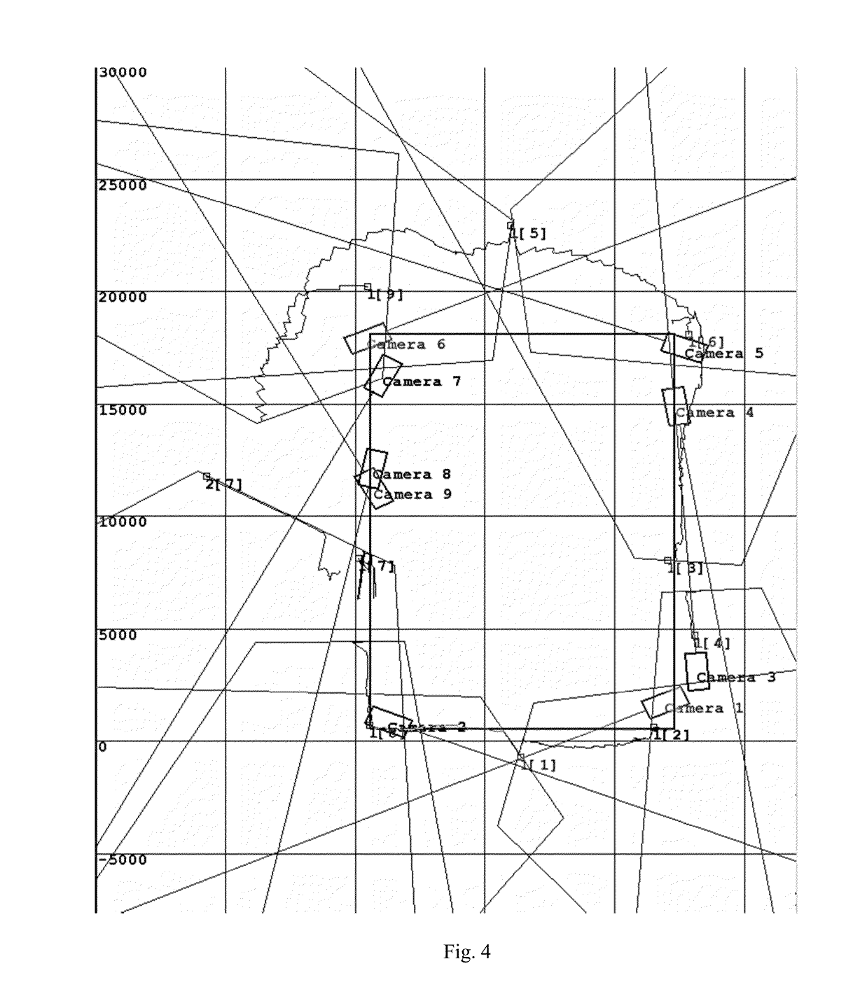

Step 1 involves receiving video—that is, one or more frames from a video camera with a CCD, CMOS, or any other sensor, such as a thermal-imaging sensor. The image can be in color or black-and-white. Sample frames acquired from a video camera are shown in FIG. 3.

Step 2. Locating Objects in the Frame

Step 2 involves using the received video data to detect at least one moving object and to locate its position and/or motion parameters in the two-dimensional coordinate system of the frame position (hereinafter, frame position). A motion detector or more complex video analytics can be used to detect a moving object. For example, FIG. 3 shows the located objects enclosed in black rectangles, and the sequence of their locations (trajectory) is shown in white. Motion parameters, such as speed (including the absolute speed value and direction) and acceleration, can be determined by the result of location (trajectories) sequence analysis.

Step 3. Mapping the Object Position from the Frame to the Map

Step 3 involves transforming the located object position and/or motion parameters from the two-dimensional frame coordinate system into a two-dimensional map coordinate system (hereinafter, map position).

A camera's field of view can be attached to the map during the initial calibration of the video-surveillance system. The best way to attach it is by point calibration (a set of points with known positions on the map is mapped to a set of points on the video frame). In the process of calibration, conversion matrix A is determined for each camera; this determination allows univocal conversion of the object position from a local position r on the frame into the global position R on the map:

$$R = A \cdot r or [ \begin{matrix}X \\ Y \\ 1\end{matrix} ] = [ \begin{matrix}{p}_{00} & {p}_{01} & {p}_{02} \\ {p}_{10} & {p}_{11} & {p}_{12} \\ {p}_{20} & {p}_{21} & {p}_{22}\end{matrix} ] [ \begin{matrix}x \\ y \\ 1\end{matrix} ]$$

For example, FIG. 4 shows separate object trajectories on the map captured by different cameras and converted into the map position.

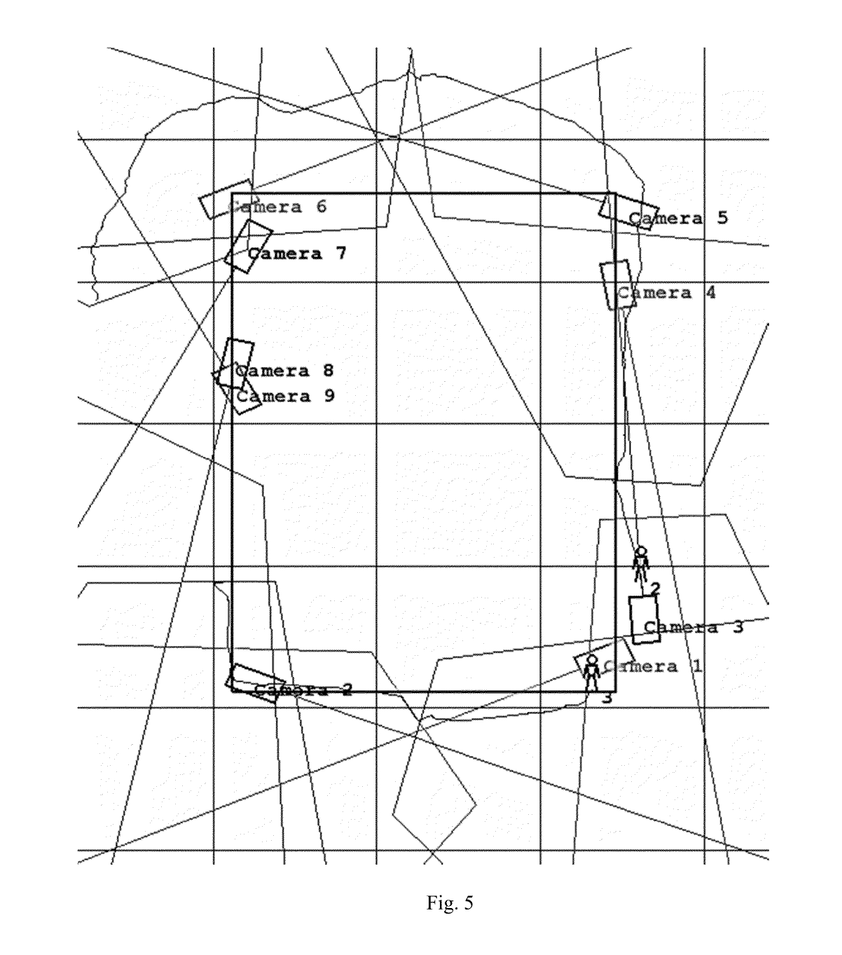

During Step 3 the motion of separate objects on the map captured by different cameras can be matched with and/or merged into an integral (joint) trajectory (shown in FIG. 5).

Merging trajectories on the map allows: a) eliminating the redundancy of object trajectory metadata in the overlapping areas of the camera view, thus reducing the amount of stored data and search time, b) implementing multi-camera analysis of the object's motion—that is, analyzing the way objects move from one camera to another, and c) precise mapping of the object—for example, by applying geodetic methods with known coordinates and orientations of the cameras.

The map positions of a single object obtained from multiple cameras can be matched and/or merged into an integral trajectory by, for example, estimating the correlation or the squared error between the object positions. If the correlation-function values within the trajectory proximity neighborhood exceed the threshold value or if the sum of the squared distances between the points of different trajectories is less than the threshold value, the trajectories are regarded as belonging to one and the same object and are merged. The integral trajectory in the merge area may contain position coordinates, averaged over the trajectories, captured by different cameras.

Step 4. Adding Index Records to Storage

Step 4 involves adding to the database or any other storage at least one index record relating (linking) the video data that contain the detected object to the object map position and/or motion parameters. Hence, a relationship between video data and the object position (motion parameters) on the map is established.

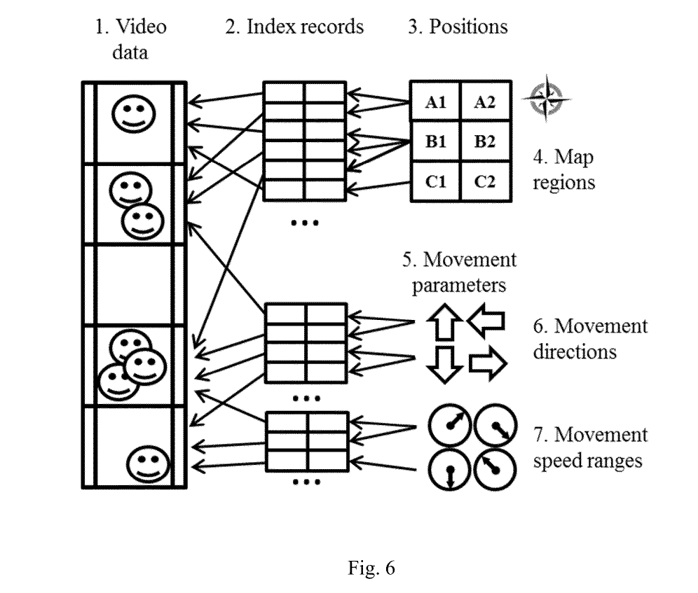

FIG. 6 shows a sample index structure with records. The map (3) is divided into areas A1, A2, B1, B2, C1, C2 and is related to the video data (1) through index records (2). The motion parameters (5), including direction (6) and speed (7), on the one hand, and video data (1), on the other hand, are related likewise. The relationship between the index record and the video data can be established by storing the frame identifier, timestamp, and/or video-data file name in the index record. The index record can be related to the position by storing in the index record either map coordinates or reference to the mapped area or to another object on the map (for example, a point or a tripwire) that the record index is based on. The index record can be related to the motion parameters in the same way.

The multiple index records shall be called an index. The index can have a tree (hierarchical) structure, such as R-tree, KD-tree, or other B-trees, to enhance search efficiency within the map space.

The R-tree divides a two-dimensional map into multiple hierarchically enclosed and, possibly, overlapping rectangles. For three-dimensional maps these shall be rectangular parallelepipeds.

R-tree index record insertion and deletion algorithms use these bounding boxes to ensure that the closely mapped video data are placed into one leaf vertex. Thus, a reference to new video data will get into the leaf vertex requiring minimum expansion of the bounding box. Each leaf vertex element can store two data fields: the video-data reference and the bounding box of the object.

Likewise, search algorithms (such as intersection, inclusion, or neighborhood) use bounding boxes to decide on the need for searching through the daughter vertex. Thus, most vertices are never involved in the search. This property of R-trees determines their applicability for the databases, where vertices can be uploaded to the disk as needed.

Splitting the full vertices may involve various algorithms, and thus they divide R-trees into subtypes: squared and linear.

Priority R-trees can be used for the worst cases of video-data mapping.

There are also other ways to divide a map into areas to correlate it with video-data index records—for example, a Voronoi diagram.

Index records may contain hashes to quickly compare the trajectory (a sequence of positions) of the object and the motion parameters (speed and direction) with the user's request.

Modern database indices, including relational databases, can also be used.

Steps 1-4 are repeated for all new video data from cameras as long as new objects start moving within the camera view.

Indexed video-data search includes the following steps (FIG. 2):

Step 5. Receiving Object Search Criteria on the Map from the User

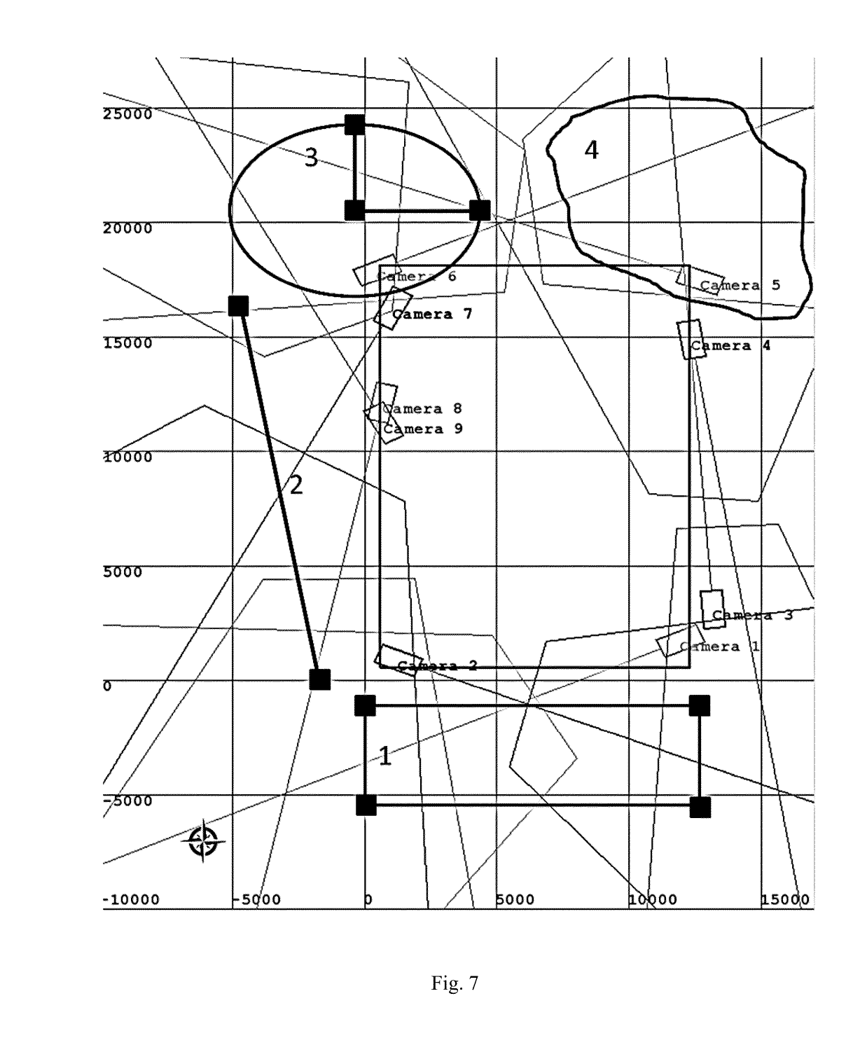

During Step 5, the user selects the search area on the map. FIG. 7 shows a sample user interface. The area selection instruments can be as follows: 1) a rectangular area, 2) a tripwire, 3) an elliptical (circular) area, or 4) an arbitrary area.

A request may be complex and include multiple search criteria. For example, the map area can be specified together with the object motion direction and time interval.

Step 6. Searching Video Data Using the Map Index

Step 6 involves a video-data search carried out according to the user's request in Step 5 by using the index created during Step 4. The index allows a considerable reduction in the amount of data matched with the user's request; using the index thus saves a lot of search time and/or decreases hardware requirements.

Step 7. Displaying the Obtained Video Data to the User

The obtained video data can be displayed to the user during Step 7 as a separate report or directly on the map. Video data can be displayed either as static frames or as video playback. Video data can be supplemented with text information, such as place and time of object (event) detection.

The video-data indexing method can be applied not only to live video (streaming video) coming from the camera but also to archived video recorded into storage (post processing).

The video-data indexing method can be applied to video-surveillance systems based on standards and/or guidelines adopted by the Open Network Video Interface Forum (ONVIF, www.onvif.org) or the Physical Security Interoperability Alliance (PSIA, psiaalliance.org). In particular, the object trajectory and/or coordinates can be transmitted via metadata, messages, and/or events according to ONVIF and/or PSIA standards.

What is claimed is:

1. A method that comprises the following steps for video-data indexing using a map:
a. Video data are obtained from at least one camera.
b. The video data are used to locate at least one moving object and to estimate the object position and/or motion parameters in the two-dimensional video frame coordinate system (the object position in the video frame).
c. The position and/or motion parameters of the located object are converted from the two-dimensional frame coordinate system into the two-dimensional map coordinate system (the object position on the map).
d. At least one index record is generated to relate the video data containing the located object to its position and/or motion parameters on the map.
e. The index record is saved in the database and/or storage.

2. A method according to claim 1, wherein the position and/or motion parameters are determined by a motion detector.

3. A method according to claim 1, wherein the position and/or motion parameters are determined by an object detector, including a person detector, a face detector, a number-plate detector.

4. A method according to claim 1, wherein the position and/or motion parameters are determined using video analytics embedded in a network camera or video server.

5. A method according to claim 1, wherein the position and/or motion parameters are determined using video analytics running on a computer server.

6. A method according to claim 1, wherein the position and/or motion parameters are refined using multispectral cameras and/or sensors operating on principles different from those of cameras (for example, radars).

7. A method according to claim 1, wherein the position and/or motion parameters are displayed on the video frame and/or map on the user monitor.

8. A method according to claim 1, wherein the video data are displayed over the map on the user monitor.

9. A method according to claim 1, wherein the located objects are identified: people are identified biometrically by their faces; vehicles are identified by their number plates.

10. A method according to claim 1, wherein the temporal sequence of object positions on the map (the object trajectory) is saved to the database and/or storage along with the index record.

11. A method according to claim 10, wherein the temporal sequence of object positions on the map (the object trajectory) is compressed before saving by a trajectory-smoothing, piecewise-linear approximation or by the spline-approximation method.

12. A method according to claim 1, wherein the object position and/or motion parameters are continuously determined in the course of the real-time object motion.

13. A method according to claim 1, wherein the video data are indexed in at least two dimensions.

14. A method according to claim 1, wherein the position is converted from the frame coordinate system into the map coordinate system by means of an affine transformation.

15. A method according to claim 1, wherein the coordinate-system transformation parameters are calculated on the basis of a one-to-one mapping between key point sets on the frame and key point sets on the map.

16. A method according to claim 1, wherein the object position on the map is determined by the data from one video camera and is refined, using multi-camera tracking methods, by comparing it with the data provided by another camera capturing the same object.

17. A method according to claim 16, wherein the positions from multiple cameras are compared and/or are merged into an integral trajectory by means of correlation or least square estimations.

18. A method according to claim 1, wherein the video camera has a support for rotation and/or zoom change using a motorized drive (a PTZ camera), and the camera's field of view is related to the map dynamically, depending on the current PTZ-camera position.

19. A method according to claim 1, wherein the index record is related to the map region, which is manually defined by the user of the video-surveillance system.

20. A method according to claim 1, wherein the index record is related to the map region defined automatically by an algorithm that divides the map into equal or unequal regions depending on the density of the objects detected in each area, whereas the regions may overlap each other.

21. A method according to claim 1, wherein the index record is related to the object motion direction.

22. A method according to claim 1, wherein the index record is related to the object motion speed.

23. A method according to claim 1, wherein the index record is related to a tripwire crossed by the object.

24. A method according to claim 1, wherein the index records are combined in a hierarchal data structure.

25. A method according to claim 1, wherein the index record is related to the moment or interval of the object motion time.

26. A method according to claim 1, wherein the index record is related to the number of objects in the area specified.

27. A method according to claim 1, wherein the index record is related to the minimum and/or maximum distance from a certain point to the object trajectory points.

28. A method according to claim 1, wherein the index record is related to the minimal bounding box of the object trajectory.

29. A method according to claim 1, wherein the index record is related to the unique object identifier.

30. A method according to claim 1, wherein the index record is related to the object type (object class).

31. A method according to claim 1, wherein the index record is related to the object motion type determined by the object motion trajectory and/or motion parameters on the map.

32. A method according to claim 1, wherein the index record is related to text tags.

33. A method according to claim 1, wherein the index records are saved in the relational database.
